(19) United States
(12) Patent Application Publication
(10) Pub. No.: US 2006/0215096 A1
(43) Pub. Date: Sep. 28, 2006

(54) LIQUID CRYSTAL DISPLAY

(76) Inventors: Yoshihisa Iwamoto, Tokyo (JP); Takashi Sugiyama, Tokyo (JP)

Correspondence Address: CERMAK & KENEALY, LLP, 515 EAST BRADDOCK RD SUITE B, Alexandria, VA, 22314, US

(21) Appl. No.: 11/277,245

(22) Filed: Mar. 23, 2006

(30) Foreign Application Priority Data
Mar. 25, 2005 (JP) 2005-088161

(51) Int. Cl. G02F 1/1337

(52) U.S. Cl. 349/130

(57) ABSTRACT

A liquid crystal display can include: first and second substrates; a first electrode formed on the first substrate; a first vertical alignment film formed above the first substrate; a second electrode formed on the second substrate; a second vertical alignment film formed above the second substrate; a liquid crystal layer sandwiched between and above the first and second substrates; a first polarizer having a first direction as a transmission axis direction and disposed facing a surface of the first substrate; and a second polarizer having a second direction as a transmission axis direction and disposed facing a surface of the second substrate, wherein the first and second polarizers are disposed, as viewed along a normal direction of the first and second substrates, in such a manner that the first direction crosses the second direction at an angle other than a right angle to realize a normally black display.

This application is based on and claims priority of Japanese Patent Application No. 2005-088161 filed on Mar. 25, 2005, the entire contents of which are incorporated herein by reference.

### BACKGROUND

A) Field

The disclosed subject matter relates to a liquid crystal display, and more particularly to a liquid crystal display of a vertical orientation type.

B) Description of Related Art

A liquid crystal display of a vertical orientation type has liquid crystal molecules disposed vertically or slightly slanted from a vertical direction on the boundary surfaces between a liquid crystal layer and two transparent substrates sandwiching the liquid crystal layer. A retardation of the liquid crystal layer is zero (0) or almost zero (0) in a front observation state. Polarizers are cross-Nicol disposed outside the liquid crystal layer to provide the quenching performance of the cross-Nicol disposed two polarizers. It is therefore possible to manufacture a display of a normally black type having good black display characteristics.

The vertical orientation type LCD is, however, associated with (susceptible to) optical transmission (or through transmission) as observed at a deep polar angle relative to an LCD panel normal direction (substrate normal direction). The degradation of viewing angle characteristics by optical transmission are conspicuous particularly when a voltage is not applied. Two main factors can be considered as the reason for forming optical transmission.

The first factor is occurrence of the birefringence effects caused by an increase in a retardation of the liquid crystal layer. A retardation A is given by the following equation (1):

$$Δ = ( \frac{{n}_{e} {n}_{o}}{\sqrt{{n}_{o} {sin}^{2} θ + {n}_{e} {cos}^{2} θ}} - {n}_{o} ) \frac{d}{cos θ}$$

where θ represents an angle of incidence light upon a liquid crystal layer (an inclination from a substrate normal direction), d represents a thickness of the liquid crystal layer, nₑ and nₒ represent an extraordinary ray refractive index and an ordinary ray refractive index of liquid crystal material.

It can be understood that the retardation Δ depends largely upon 1/cosθ and increases as the angle θ of incidence light upon the liquid crystal layer increases toward 90° so that the birefringence effects occur, resulting in optical transmission.

The second factor is the polarizers. If the polarizers are cross-Nicol disposed outside the upper and lower substrates, the layout of the upper and lower polarizers shifts from the cross-Nicol state as the polar observation angle is increased, except when the polar observation angle is changed to the transmission or absorption axis of the polarizer. As observed along the in-plane direction (substrate in-plane direction) of an LCD panel, a perfect parallel Nicol state is established. Namely, as the observation angle is increased with respect to the normal direction, the polarizer cross-Nicol state is extinguished and optical transmission occurs.

FIG. 9 is a schematic broken perspective view of a vertical orientation type LCD using a viewing angle compensation film. The vertical orientation type LCD is constituted of a pair of substrates (upper and lower substrates 31 and 32) and a liquid crystal layer 39 sandwiched between the substrates. The upper and lower substrates 31 and 32 are constituted of: upper and lower transparent substrates 33 and 34 of, e.g., flat glass plates; upper and lower transparent electrodes 35 and 36 made of transparent conductive material such as indium tin oxide (ITO) formed on the inner surfaces of the upper and lower transparent substrates 33 and 34 and having predetermined patterns; and upper and lower vertical alignment films 37 and 38 covering the upper and lower transparent electrodes 35 and 36, respectively.

The pair of substrates (upper and lower substrates 31 and 32) are disposed in a generally parallel configuration with respect to each other, and with the vertical alignment films 37 and 38 facing each other and squeezing the liquid crystal layer 39. A voltage applying unit 43 can be connected across the transparent electrodes 35 and 36 and can apply an arbitrary voltage to the liquid crystal layer 39 between the transparent electrodes 35 and 36. FIG. 9 shows the orientation state of a liquid crystal layer that does not have a voltage applied across the transparent electrodes 35 and 36. The upper and lower vertical alignment films 37 and 38 have a pre-tilt angle of about 89° imparted by a rubbing process.

Outside of the pair of substrates (upper and lower substrates 31 and 32), a pair of upper and lower polarizers 41 and 42 are disposed in a generally parallel relationship in a cross-Nicol state. Each arrow indicates the direction of a transmission axis of each of the polarizers 41 and 42. The direction of an absorption axis is perpendicular to the transmission axis direction. Each of the polarizers 41 and 42 transmits only the light polarized in the transmission axis direction.

While no voltage is applied, upward incident light is polarized along the arrow direction by the lower polarizer 42, transmits through the liquid crystal layer 39 and is intercepted by the upper polarizer 41. Therefore, the vertical orientation type LCD displays “black”.

While voltage is applied, the orientation state of liquid crystal molecules 39a changes from the state under no voltage application. Therefore, light upward incident from the lower polarizer 42 has optical components along the transmission axis direction of the upper polarizer 41 so that the light transmits through the upper polarizer 41 and the vertical orientation type LCD displays “white”.

A viewing angle compensation film (phase difference film) 45 can be inserted between the upper substrate 31 and upper polarizer 41. If the viewing angle compensation film 45 is inserted, light transmission caused by the above-described first factor can be reduced or prevented.

The viewing angle compensation film can include various materials, including a transparent medium having negative uniaxial optical anisotropy whose refractive index in an in-plane direction is smaller than that in a thickness direction, or a transparent medium having negative biaxial optical anisotropy and a delay phase axis in an in-plane direction of the compensation film, etc. In the case of the compensation film having the negative biaxial optical anisotropy, the delay phase axis in the in-plane direction is parallel to the transmission axis of one of the two polarizers.

The viewing angle compensation film 45 may be inserted between one substrate and polarizer as shown in FIG. 9 or it may be inserted between both the substrates and polarizers.

The viewing angle compensation film is used in at least the following arrangements.

A first arrangement includes polarizers disposed in a cross-Nicol state on both upper and lower sides of vertical orientation cells, and a viewing angle compensation film (phase difference film) having negative uniaxial optical anisotropy whose optical axis is substantially along the normal direction of the viewing angle compensation film, and being disposed between one polarizer and vertical orientation cells.

A second arrangement includes polarizers disposed in a cross-Nicol state on both upper and lower sides of vertical orientation cells, and a viewing angle compensation film (phase difference film) having negative uniaxial optical anisotropy whose optical axis is substantially along the normal direction of the viewing angle compensation film, and being disposed between both polarizers and vertical orientation cells.

A third arrangement includes polarizers disposed in a cross-Nicol state on both upper and lower sides of vertical orientation cells, and a viewing angle compensation film (phase difference film) having negative biaxial optical anisotropy whose delay phase axis in the in-plane direction is substantially parallel to the transmission axis of one of the two polarizers and substantially perpendicular to the transmission axis of the other polarizer, and being disposed between one polarizer and vertical orientation cells.

A fourth arrangement includes polarizers disposed in a cross-Nicol state on both upper and lower sides of vertical orientation cells, and a viewing angle compensation film (phase difference film) having negative biaxial optical anisotropy whose delay phase axis in the in-plane direction is substantially parallel to the transmission axis of one of the two polarizers and substantially perpendicular to the transmission axis of the other polarizer, and being disposed between both polarizers and vertical orientation cells, the phase delay axes being substantially perpendicular.

As shown in FIG. 9, a right-hand coordinate system is introduced in which X- and Y-directions (positive directions are in the arrow directions) are defined which are substantially perpendicular in the in-plane directions of the upper and lower substrates 31 and 32, and a Z-axis is defined which is substantially perpendicular to the surfaces of the upper and lower substrates 31 and 32 and has a positive direction from the lower substrate 32 toward the upper substrate 31. An angular coordinate in the in-plane direction of the substrate is defined counterclockwise (in a rotation direction toward the positive Y-direction) starting from the positive X-direction at 0°, as viewing the upper and lower substrates 31 and 32 along the positive Z-direction. With this angular coordinate, the positive Y-direction is a 90° direction, a negative X-direction is a 180° direction and a negative Y-direction is a 270° direction. A direction (an arrow direction) of the transmission axis of the upper polarizer 41 can be a substantially 45°/225° direction, and a direction of the transmission axis of the lower polarizer 42 can be a substantially 135°/315° direction.

FIG. 10 is a graph showing a calculation example of a polar observation angle dependency of an optical transmissivity of a vertical orientation type LCD with or without the viewing angle compensation film (phase difference film).

Calculations were made for the vertical orientation type LCD shown in FIG. 9 and for a vertical orientation type LCD removing the viewing angle compensation film 45 from the vertical orientation type LCD shown in FIG. 9. The viewing angle compensation film 45 had a retardation Rth in a thickness direction of about 0.9 time the retardation Δ of the liquid crystal layer 39 and had a retardation Re in an in-plane direction of 3 nm in negative biaxial optical anisotropy. The delay phase axis in the in-plane direction was the 45°/225° direction.

The abscissa represents an observation angle (polar angle) in the unit of “° (degree)”. This angle (observation angle, polar angle) is a tilt angle from the positive Z-direction to the positive X-direction (0° azimuth) or negative X-direction (180° azimuth). The tilt angle from the positive Z-direction to positive X-direction (00 azimuth) is indicated by a positive value and the tilt angle from the positive Z-direction to negative X-direction (180° azimuth) is indicated by a negative value. The absolute value of a negative observation angle is equal to the tilt angle from the positive Z-direction to negative X-direction (180° azimuth).

The ordinate represents an optical transmissivity at each observation angle in the unit of “%”.

Curve “a” shows the relation between an observation angle and an optical transmissivity of the vertical orientation type LCD without the viewing angle compensation film, and curve “b” shows the relation between an observation angle and an optical transmissivity of the vertical orientation type LCD with the viewing angle compensation film.

It can be seen from the graph that at the polar angle of about 20° or larger, the optical transmissivity of the vertical orientation type LCD without the viewing angle compensation film is smaller than that of the vertical orientation type LCD with the viewing angle compensation film, and at a polar angle of 60°, the former is half or smaller than the latter.

As seen from curve “b”, even the vertical orientation type LCD with the viewing angle compensation film cannot achieve an optical transmissivity equal to zero (0). This is a result from the above-described second optical transmission factor.

In order to eliminate optical transmission due to the second factor, a linearly polarized light vibration plane can be rotated in such a manner that linearly polarized light emitted from the light input side polarizer becomes uniformly parallel to the absorption axis of the light output side polarizer. A method of realizing this may include inserting a half wavelength film between the polarizers and setting the delay phase axis substantially parallel to the absorption axis of one of the polarizers. The half wavelength film has a half wavelength at any polar observation angle.

In order to realize this performance, a very special phase difference film can be used which has positive biaxial optical anisotropy and is designed in such a manner that a refractive index in the in-plane direction is larger than that in the thickness direction and a phase difference of a half wavelength is established in the in-plane direction.

FIG. 11 is a graph showing the relation between an observation angle (polar angle) and an optical transmissivity of a vertical orientation LCD with or without the phase difference film having positive biaxial optical anisotropy.

The abscissa and ordinate of the graph showing in FIG. 11 have the same meanings as those of the graph shown in FIG. 10.

Curve “c” indicates the relation between an observation angle (polar angle) and an optical transmissivity when light is made incident from the lower polarizer side, with a viewing angle compensation film being sandwiched between two polarizers in a stacked manner. The layout of the upper and lower polarizers is the same as that of the polarizers of the vertical orientation type LCD shown in FIG. 9. Namely, the polarizers were disposed in such a manner that the transmission axis direction of the upper polarizer was the 45°/225° direction and the transmission axis direction of the lower polarizer was the 135°/315° direction. Curve “d” indicates the relation between an observation angle (polar angle) and an optical transmissivity when light is made incident from the lower polarizer side, with a phase difference film having positive biaxial optical anisotropy being further sandwiched between the upper polarizer and viewing angle compensation film in a stacked manner with the lower polarizer. The layout of the upper and lower polarizers is the same as that of the polarizers of the vertical orientation type LCD shown in FIG. 9. A phase difference in the in-plane direction of the phase difference film having positive biaxial optical anisotropy was set to a half wavelength and that in the thickness direction was set to half of the half wavelength (quarter wavelength). The phase difference film (half wavelength film) was disposed, with its delay phase axis direction being set to the substantially 45°/225° direction.

As apparent from the comparison between the curves “c” and “d”, optical transmission can be substantially eliminated even at an observation angle (polar angle) of 20° or larger, by inserting the phase difference film having positive biaxial optical anisotropy.

Optical transmission can be removed almost perfectly by using the viewing angle compensation film and the phase difference film having positive biaxial optical anisotropy (e.g., refer to the publication entitled “Wide Viewing Angle Polarizer Using Biaxial Film” by S. Yano, et. al. IDW′ 00, pp. 419-422).

### SUMMARY

According to one aspect of the disclosed subject matter, a liquid crystal display can include: first and second substrates disposed generally parallel and facing each other; a first electrode formed on an opposing surface of the first substrate; a first vertical alignment film formed above the opposing surface of the first substrate and covering the first electrode; a second electrode formed on an opposing surface of the second substrate; a second vertical alignment film formed above the opposing surface of the second substrate and covering the second electrode; a liquid crystal layer sandwiched between and above the opposing surfaces of the first and second substrates; a first polarizer having a first direction as a transmission axis direction and disposed facing a surface of the first substrate opposite to the liquid crystal layer; and a second polarizer having a second direction as a transmission axis direction and disposed facing a surface of the second substrate opposite to the liquid crystal layer, wherein the first and second polarizers are disposed, as viewed along a normal direction of the first and second substrates, in such a manner that the first direction crosses the second direction at an angle other than a right angle to realize a normally black display.

This liquid crystal display can realize a good display quality in oblique observation.

According to the disclosed subject matter, it is possible to provide a liquid crystal display having a good display quality.

### BRIEF DESCRIPTION OF THE DRAWINGS

FIG. 1 is a diagram defining a shift angle between transmission axes of upper and lower polarizers and other parameters.

FIG. 2 is a graph showing a shift angle dependency of optical transmissivity in front observation in actually measured values and theoretical values.

FIGS. 3A and 3B are graphs showing simulation results and actually measured values of polar observation angle dependency related to optical transmissivity for a vertical orientation type LCD.

FIGS. 4A to 4D are graphs showing a shift angle dependency of optical transmissivity using equi-luminance lines.

FIG. 5 is a schematic broken perspective view showing an example of the internal structure of a vertical orientation type LCD according to an embodiment.

FIG. 6 is a schematic diagram showing the inside of a vehicle that includes a vertical orientation type LCD according to an embodiment, as viewed behind the vehicle (from a rear seat).

FIGS. 7A and 7B are schematic broken perspective views showing an example of the internal structure of a vertical orientation type LCD according to anotherembodiment.

FIGS. 8A and 8B are schematic broken perspective views showing another example of the internal structure of a vertical orientation type LCD according to another embodiment.

FIG. 9 is a schematic broken perspective view of a vertical orientation type LCD using a viewing angle compensation film.

FIG. 10 is a graph showing calculation results of polar observation angle dependency with respect to optical transmissivity for a vertical orientation type LCD with and without a viewing angle compensation film.

FIG. 11 is a graph showing the relation between observation angle (polar angle) and optical transmissivity when a phase difference film having positive biaxial optical anisotropy is used and is not used.

FIG. 12 is a graph showing the relation between right/left observation angle and optical transmissivity, at various retardation values Re in the in-plane direction for a viewing angle compensation film of the vertical orientation type LCD having the structure shown in FIG. 5.

### DESCRIPTION OF EXEMPLARY EMBODIMENTS

Good viewing angle characteristics of a liquid crystal display in omni-directions are not necessarily required depending upon its application field.

For example, if a display is mounted on a so-called center console of a vehicle between a driver seat and an assistant seat, the viewing angle characteristics particularly along a right/left direction are important. It is practical to ensure a high display quality in right/left inclination observation rather than in front observation.

As described earlier, optical transmission of a liquid crystal display using cross-Nicol polarizers increases as an observation angle (polar angle) increases, because the angle between transmission axes (absorption axes) of upper and lower polarizers as viewed from an observation position shifts from 90°.

Improvement in display quality in oblique observation of a liquid crystal display can be realized by shifting from 90° the angle between transmission axes (absorption axes) of upper and lower polarizers as viewed along a front observation direction (substrate normal direction).

Further description of simulation results and actual measurement results of the effects obtained by shifting from 90° the angle between transmission axes (absorption axes) of upper and lower polarizers is provided below.

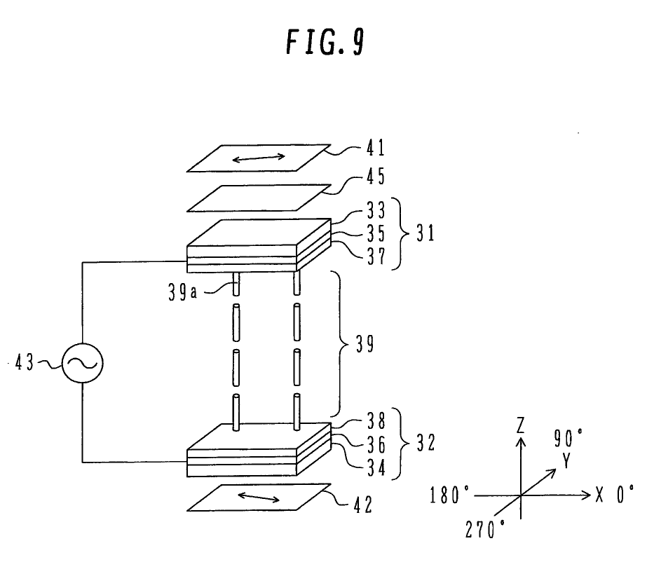

An LCD simulator, for this example, LCD Master 6.0 manufactured by SHINTECH, Inc., was used for simulation. Simulation and actual measurements were made for a vertical orientation type LCD of a mono-domain type having the structure shown in FIG. 9. A retardation A of the liquid crystal layer was 360 nm, an in-plane retardation Re of the viewing angle compensation film was 3 nm and its depth direction retardation Rth was 310 nm. Polarizers, in this example, SKN-18243T manufactured by Polatechno Co., Ltd., were used as the upper and lower polarizers. A pre-tilt angle between the liquid crystal layer and vertical alignment film was uniform at 89°, and liquid crystal molecules were oriented in a non-parallel fashion on upper and lower substrates. A tilt azimuth of liquid crystal molecules during voltage application was set to the 270° azimuth in the angular coordinate system shown in FIG. 9. The coordinate system defined in FIG. 9 is used, unless otherwise specifically denoted.

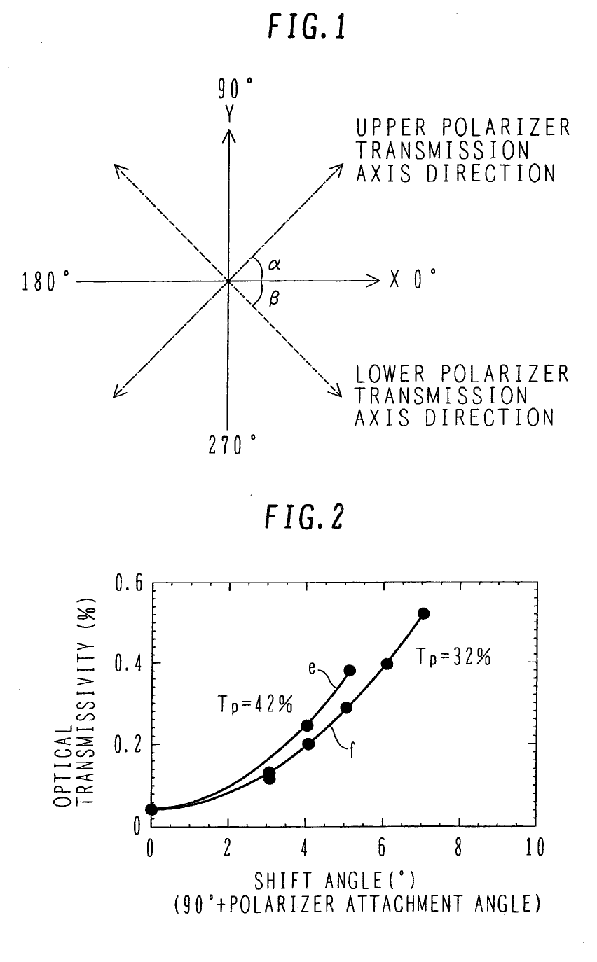

With reference to FIG. 1, a shift angle between transmission axes of upper and lower polarizers and others will be defined. FIG. 1 is a diagram observed along the normal direction of upper and lower substrates of a vertical orientation type LCD.

The dot—dash arrow of FIG. 1 indicates a transmission axis direction of the upper polarizer. The broken line arrow indicates a transmission axis direction of the lower polarizer. The following studies assume that an angle α between the former direction and a 0° azimuth is equal to an angle β between the latter and 0° azimuth. A “shift angle” is defined as an angle (e.g., α+β) between the transmission axes of the upper and lower polarizers shifted from 90° toward the positive direction (i.e., α+β−90°).

FIG. 2 shows shift angle dependency for optical transmissivity in front observation represented by actually measured values and theoretical values.

The abscissa represents the shift angle in the unit of “° (degree)” and the ordinate represents optical transmissivity in the unit of “%”. Curve “e” indicates actually measured results and a curve “f” indicates values obtained from the theoretical formula.

As the shift angle becomes large, the optical transmissivities in front observation represented by actually measured values and theoretical values increase. If the optical transmissivity while the “bright” is displayed by applying a voltage is 20%, the shift angle obtained at a contrast CR=50 (optical transmissivity is 0.4%) is about 50 in an actually measured value, and about 60 in a theoretical value. If CR of 100 or larger (optical transmissivity is 0.2% or smaller) is necessary, it is desired to set the shift angle to about 40 or smaller in an actually measured value.

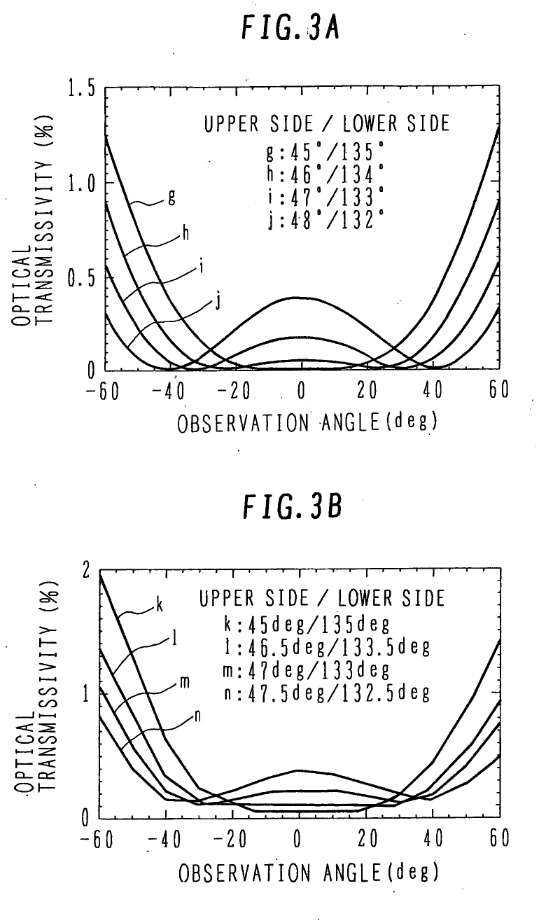

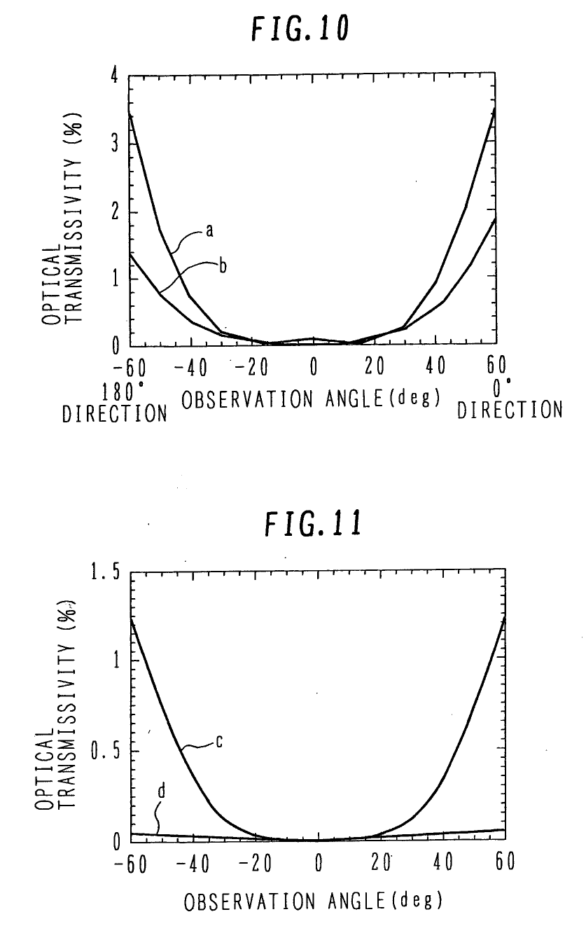

FIGS. 3A and 3B are graphs showing simulation results and actual measurement results of polar observation angle dependency with respect to optical transmissivity for a vertical orientation type LCD. FIGS. 3A and 3B both show the polar observation angle dependency with respect to optical transmissivity along the 180°/0° azimuth (left/right direction of the LCD panel) defined with reference to FIG. 9. The abscissa and ordinate of the graphs of FIGS. 3A and 3B have the same meanings as those of the graph of FIG. 10.

Reference is made to FIG. 3A. Curves “g,” “h,” “i” and “j” shown in FIG. 3A indicate optical transmissivities under the conditions that the transmission axes of the upper polarizers are substantially 45°/225°, 46°/226°, 47°/227° and 48/228° directions, respectively and the transmission axes of the lower polarizers are substantially 135°/315°, 134°/314°, 133°/313° and 132°/312° directions, respectively. Namely, the curves “g,” “h,” “i” and “j” indicate optical transmissivities under the conditions that the shift angles are 0°, 2°, 4° and 6°, respectively.

It can be understood that as the shift angle becomes large, although the optical transmission in front observation increases, the polar observation angle range without optical transmission becomes larger. It can also be understood that in observation at the polar angle of 40° or 60° , the optical transmission becomes small as the shift angle becomes large. As above, by disposing the polarizers with a shift angle, the viewing angle characteristics can be improved along oblique directions at right and left azimuths.

Reference is made to FIG. 3B. Curves “k,” “l,” “m” and “n” shown in FIG. 3B which indicate optical transmissivities under the conditions that the transmission axes of the upper polarizers are substantially 45°/225°, 46.5°/226.5°, 47°/227° and 47.5°/227.5° directions, respectively and the transmission axes of the lower polarizers are substantially 135°/315°, 133.5°/313.5°, 133°/313° and 132.5°/312.5° directions, respectively. Namely, the “l,” “m” and “n” indicate optical transmissivities under the conditions that the shift angles are substantially 0°, 3°, 4° and 5°, respectively.

Results that are similar to those of the simulation results are also obtained for actual measurement results.

The results of studies have taught that since the optical transmission in front observation becomes large as the shift angle is made large, it is possible to obtain good characterisics by setting the shift angle to 6° or smaller. The shift angle can also be set to a range of between about 1° and 5° to obtain good characteristics in view of the tradeoff between optical transmission and shift effects.

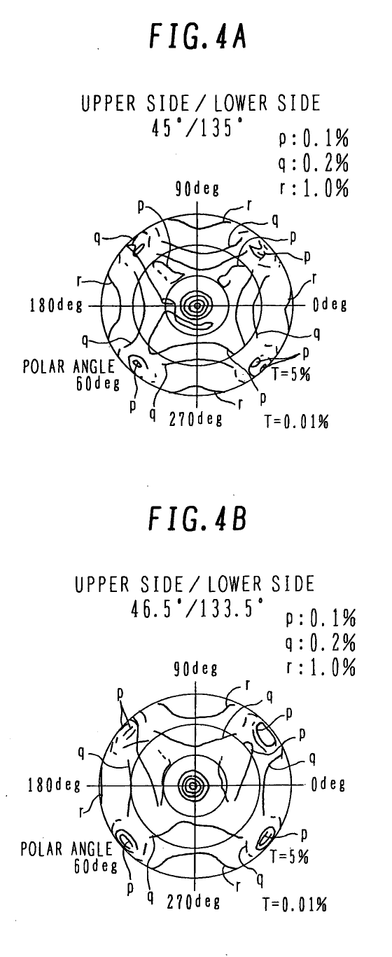

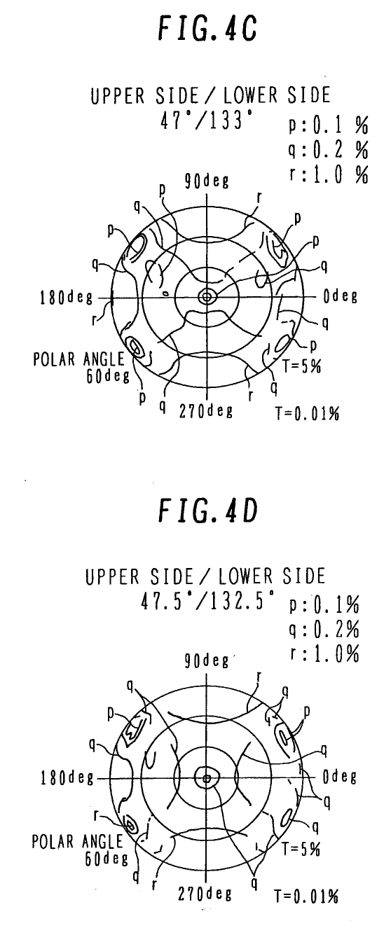

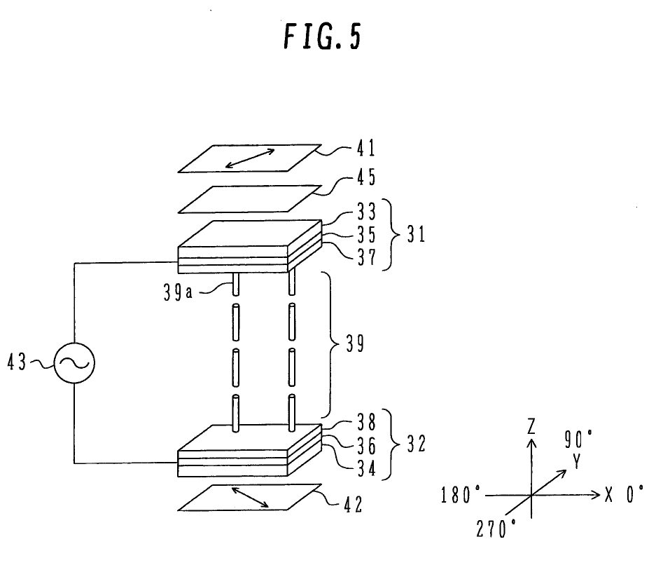

FIGS. 4A to 4D show shift angle dependency with respect to optical transmissivity, using equi-luminance lines. FIGS. 4A to 4D show the state of optical transmission by equi-luminance lines as the polar observation angle is set to each azimuth angle direction.

In the graphs, three concentric circles indicate the positions at the polar angle of substantially 20°, 40° and 60° in the order from the inner circle. The center of the concentric circle is the position at the polar angle of 0°. Curves “p,” “q” and “r” indicate the equi-luminance lines at the optical transmissivities of 0.1%, 0.2% and 1.0%, respectively.

FIG. 4A shows equi-luminance lines with the transmission axes of the upper and lower polarizers being set to substantially 45°/225° and 135°/315° directions, respectively.

FIGS. 4B, 4C and 4D show equi-luminance lines with the transmission axes of the upper and lower polarizers being set to substantially 46.5°/226.5° and 133.5°/313.5° directions, respectively for FIG. 4B, to substantially 47°/227° and 133°/313° directions, respectively for FIG. 4C, and to substantially 47.5°/227.5° and 132.5°/312.5° directions, respectively for FIG. 4D.

As the shift angle becomes large, for example, the curve “q” (curve with the optical transmissivity of 0.2%) moves to the position outside the concentric circle (in the deeper polar angle direction), along the left/right (180°/0°) direction.

The tendency opposite to this can be recognized in the up/down (90°/270°) direction.

This suggests that the optical transmission is suppressed in the left/right (180°/0°) direction and enhanced in the up/down (90°/270°) direction.

As above, the viewing angle characteristics in the right/left direction can be improved by using the positive shift angle in the right/left direction.

The viewing angle characteristics in the up/down direction can be improved by using the negative shift angle (the positive shift angle in the up/down direction) in the right/left direction.

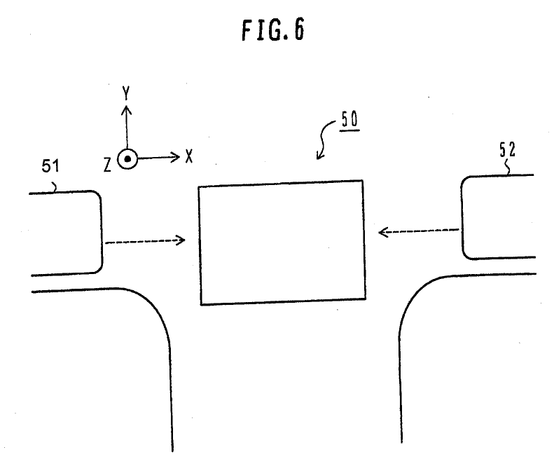

FIG. 5 is a schematic broken perspective view showing an example of the internal structure of a vertical orientation type LCD according to an embodiment. The coordinate system shown in FIG. 9 is also applied to FIG. 5.

The vertical orientation type LCD can include a pair of substrates (upper and lower substrates 31 and 32) and a liquid crystal layer 39 sandwiched between the substrates. For example, the liquid crystal layer can be made of a nematic liquid crystal layer containing nematic liquid crystals 39a having negative dielectric anisotropy (Δε<0).

The upper and lower substrates 31 and 32 can include: upper and lower transparent substrates 33 and 34 of, e.g., flat glass plates; upper and lower transparent electrodes 35 and 36 made of transparent conductive material such as indium tin oxide (ITO), formed on the inner surfaces of the upper and lower transparent substrates 33 and 34 and having predetermined patterns; and upper and lower vertical alignment films 37 and 38 covering the upper and lower transparent electrodes 35 and 36, respectively.

The pair of substrates (upper and lower substrates 31 and 32) can be disposed generally parallel to the vertical alignment films 37 and 38 facing each other and sandwiching the liquid crystal layer 39. A retardation Δ of the liquid crystal layer 39 is, for example, 360 nm.

A voltage applying unit 43 can be connected across the transparent electrodes 35 and 36 and can apply an arbitrary voltage to the liquid crystal layer 39 between the transparent electrodes 35 and 36. A rubbing process or alignment process is performed uniformly and equally for the upper and lower vertical alignment films 37 and 38 in a non-parallel direction relative to the upper and lower substrates 31 and 32 to impart a pre-tilt angle of about 89°. With the alignment process of imparting the pre-tilt angle, liquid crystal molecules in the liquid crystal layer 39 in contact with the vertical alignment films 37 and 38 are aligned generally in a vertical direction (direction tilted by 1° from the vertical direction) relative to the substrates (upper and lower substrates 31 and 32). A tilt azimuth of liquid crystal molecules during voltage application is, for example, 270°.

Outside of the pair of substrates (upper and lower substrates 31 and 32), a pair of upper and lower polarizers 41 and 42 are disposed generally parallel in the in-plane direction. For example, the upper and lower polarizers can be SKN-18243T manufactured by Polatechno Co., Ltd.

Each arrow indicates the direction of a transmission axis of each of the polarizers 41 and 42. An angle between the transmission axes of the upper and lower polarizers 41 and 42 can be larger than 90° on both sides of the 0°/180° direction as viewed along the normal direction of the upper and lower substrates 31 and 32, e.g., 93°. For example, the direction of the transmission axis of the upper polarizer 41 can be the 46.5°/226.5° direction, and the direction of the transmission axis of the lower polarizer 42 can be the 133.5°/313.5° direction. The 0°/180° direction is, for example, a positive projection direction to a substrate in-plane of an observation direction.

As described earlier, the shift angle can be 6° or smaller and can be between 1° and 5° Namely, an angle between the transmission axes of the upper and lower polarizers 41 and 42 cna be larger than 90° and 96° or smaller on both sides of the 0°/180° direction as viewed along the normal direction of the upper and lower substrates 31 and 32, and can be 910 or larger and 95° or smaller.

A viewing angle compensation film (phase difference film) 45 can be inserted between the upper substrate 31 and upper polarizer 41, the in-plane direction of the upper polarizer 41 being set generally parallel to the in-plane direction of the viewing angle compensation film. For example, the viewing angle compensation film 45 can be made of a transparent medium having negative biaxial optical anisotropy having a delay phase axis in the in-plane of the compensation film. The viewing angle compensation film 45 may be made of a transparent medium having negative uniaxial optical anisotropy having a refractive index in the in-plane direction higher than a refractive index in the thickness direction.

A retardation Rth of the viewing angle compensation film 45 in the thickness direction can be 0.5 time or larger and 1.2 times or smaller than a retardation Δ when no application of voltage is applied to the liquid crystal layer, e.g., 310 nm, in both cases of using the transparent medium having negative uniaxial optical anisotropy and using the transparent medium having negative biaxial optical anisotropy. The retardation Re of the compensation film in the in-plane direction can be 1 nm or larger and 80 nm or smaller, e.g., 3 nm in the case of the vertical orientation type LCD of the embodiment.

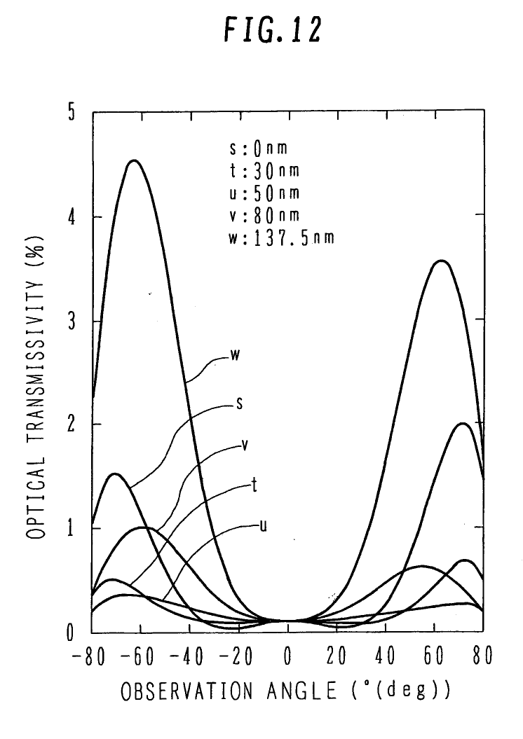

With reference to FIG. 12, description will be made on why the retardation Re of the compensation film having negative biaxial optical anisotropy in the in-plane direction can be 1 nm or larger and 80 nm or smaller.

FIG. 12 is a graph showing the relation between a right/left observation angle (0°/180° azimuth) and an optical transmissivity at different retardations Re of the viewing angle compensation film 45 in the in-plane direction of the vertical orientation type LCD having the structure shown in FIG. 5. (The direction of the transmission axis of the upper polarizer 41 is the 46.5°/226.5° direction, the direction of the transmission axis of the lower polarizer 42 is the 133.5°/313.5° direction, and the shift angle is 3°. The retardation Rth of the viewing angle compensation film 45 is 310 nm and the delay phase axis in the in-plane direction is parallel to the transmission axis of the upper polarizer 41).

The abscissa represents a right/left observation angle in the unit of “° (degree)” and the ordinate represents an optical transmissivity in the unit of “%”. A wavelength of light incident upon LCD can be approximatley 550 nm.

Curve “s” indicates the relation between the right/left observation angle and an optical transmissivity at a retardation Re of 0 nm in the in-plane direction, i.e., the viewing angle compensation film has negative uniaxial optical anisotropy. Curves “t,” “U,” “v” and “w” indicate the relations at the in-plane direction retardations of 30 nm, 50 nm, 80 nm and 137.5 nm (quarter wavelength of incidence light).

The retardation Re of 80 nm or smaller satisfies in that an optical transmissivity at the right/left observation angle of 60° is smaller than that at the in-plane direction retardation Re of 0 nm.

In order to obtain the practical effects of using the viewing angle compensation film having negative biaxial optical anisotropy, the range from 1 nm or larger and 80 nm or smaller can be used for the in-plane direction retardation Re.

Reference is reverted to FIG. 5. The delay phase axis of the viewing angle compensation film 45 in the in-plane direction can be parallel to the transmission axis of the upper polarizer 41 (polarizer near the viewing angle compensation film 45), or may be perpendicular. It is not necessary that the in-plane direction delay phase axis is parallel or perpendicular to the transmission axis of one of the two polarizers 41 and 42. If the delay phase axis is parallel or perpendicular to the transmission axis of one of the two polarizers 41 and 42, particularly that of the polarizer near the viewing angle compensation film 45, there is a merit that a liquid crystal display can be manufactured easily, contributing to low cost manufacture.

If a liquid crystal display is manufactured with the polarizer adhered to the viewing angle compensation film, position alignment is easy and the same extension direction can be used. Even if the polarizer is not adhered to the film, position alignment is easy.

The viewing angle compensation film 45 may be inserted between one substrate and corresponding polarizer generally in parallel as shown in FIG. 5 or it may be inserted between the substrates and polarizers generally in parallel. If the viewing angle compensation film 45 made of transparent medium having negative biaxial optical anisotropy is inserted between the substrates and polarizers, the in-plane direction delay phase axes of the two viewing angle compensation films 45 can be disposed parallel or perpendicular to the transmission axis of the polarizer near the viewing angle compensation film. In other words, the directions of the in-plane delay phase axes of the two viewing angle compensation films 45 are not necessary to be perpendicular to each other. It is not necessary to dispose the two viewing angle compensation films 45 in such a manner that the directions of the in-plane delay phase axes of the two viewing angle compensation films 45 are made parallel to each other.

The liquid crystal display can be manufactured easily and at a low cost by setting the in-plane direction delay phase axes of the two viewing angle compensation films 45 parallel or perpendicular to the transmission axis of the polarizer near the viewing angle compensation film.

When no voltage is applied, light incident upward is polarized by the lower polarizer 42 along the arrow direction, transmits through the liquid crystal layer 39, and most of the light is intercepted by the upper polarizer 41. The vertical orientation type LCD therefore displays “black”. The vertical orientation type LCD of the embodiment is a normally black type liquid crystal display.

FIG. 6 is a schematic diagram showing the inside of a vehicle including a vertical orientation type LCD of the embodiment, as viewed from the vehicle rear side (rear seat). In FIG. 6, a vertical orientation type LCD 50 is located at a middle portion between a driver seat 51 and an assistant seat 52. The directions of X, Y and Z axes shown in FIG. 6 correspond to those shown in FIG. 5.

In FIG. 6, lines of sight from the driver seat 51 and assistant seat 52 to the vertical orientation type LCD are indicated by broken-line arrows. The line of sight from the driver seat 51 to the vertical orientation type LCD 50 is a direction (0° direction) tilted from the substrate vertical direction (positive Z-direction) to the positive X-direction. The line of sight from the assistant seat 52 to the vertical orientation type LCD 50 is a direction (180° direction) tilted from the substrate vertical direction (positive Z-direction) to the negative X-direction.

The vertical orientation type LCD of the embodiment shown in FIG. 5 is particularly suitable for a vehicle mounted vertical orientation type LCD mainly used for oblique observation. For example, the screen of the vehicle mounted vertical orientation type LCD shown in FIG. 6 can be mainly observed from the driver seat and assistant seat. Since these observation directions (observation angles) are almost fixed, for example, the shift angle is set in such a manner that the optical transmissivities at the observation angles are minimized. For a vehicle mounted liquid crystal display, the angle of the transmission axis relative to the width direction of the vehicle body can be larger than 90° and equal to or less than 96°, or can be 91° or larger and equal to or less than 95°.

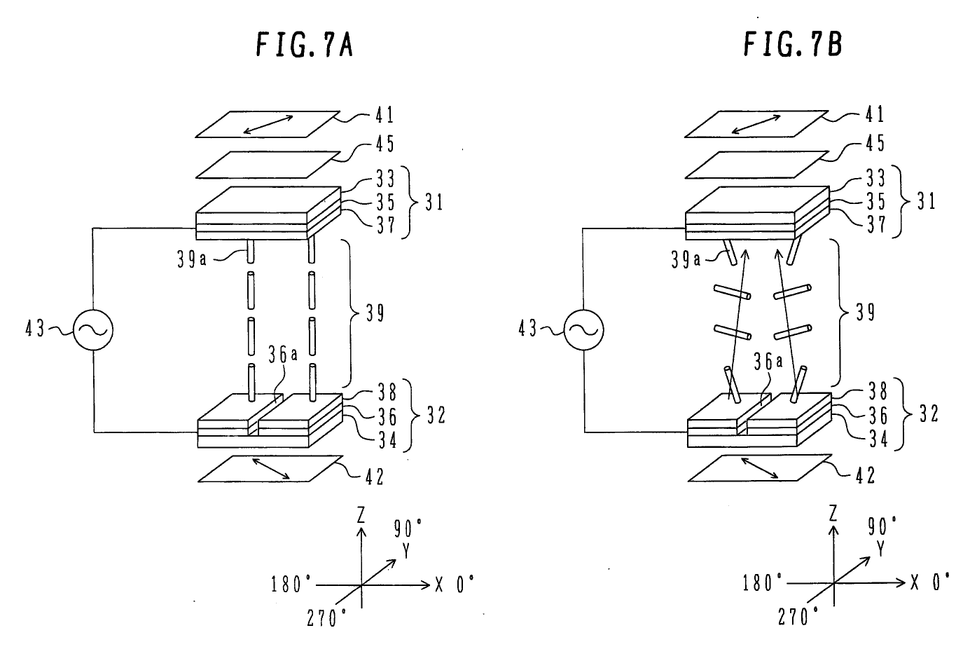

FIGS. 7A and 7B are schematic broken perspective views showing another example of the internal structure of a vertical orientation type LCD according to another embodiment. The polarizer, viewing angle compensation film and the like can be similar to those of the embodiment of FIG. 5.

Reference is made to FIG. 7A. An upper transparent electrode 36 of a vertical orientation type LCD shown in FIG. 7A can include a slit 36a of, for example, having a rectangular shape in cross section. FIG. 7A shows the orientation state of a liquid crystal layer 39 while a voltage is not applied across the transparent electrodes 35 and 36. An alignment process is not performed for upper and lower vertical alignment films 37 and 38. Therefore, the upper and lower vertical alignment films 37 and 38 vertically align liquid crystal molecules 39a relative to upper and lower substrates 31 and 32 while no voltage is applied. Under no voltage application, the vertical orientation type LCD displays “dark”.

Reference is made to FIG. 7B. FIG. 7B shows the orientation state of the liquid crystal layer 39 when a voltage is applied.

An electric field is generated near the slit 36a in a slanted direction relative to the substrate surface. In FIG. 7B, the direction of the electric field is indicated by arrows in the liquid crystal layer 39.

Since a director of each liquid crystal molecule 39a is aligned perpendicular to the electric field, a liquid crystal display of a multi domain structure can be realized. The vertical orientation type LCD displays “bright” under voltage application.

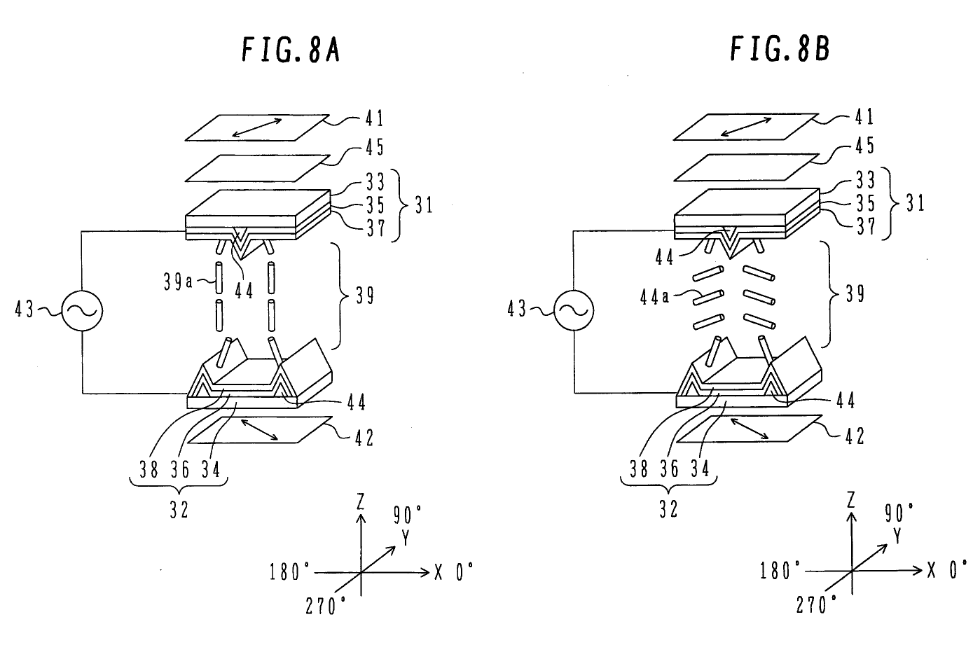

FIGS. 8A and 8B are schematic broken perspective views showing another example of the internal structure of a vertical orientation type LCD according to another embodiment. The polarizer, viewing angle compensation film and the like can be similar to those of the embodiment of FIG. 5.

Reference is made to FIG. 8A. In the vertical orientation type LCD shown in FIGS. 7A and 7B, the slit 36a is formed in the transparent electrode 36. In the vertical orientation type LCD shown in FIGS. 8A and 8B, projections 44 can be used as alignment control elements and provided on upper and lower substrates 31 and 32 (upper and lower transparent substrates 33 and 34).

FIG. 8A shows the orientation state of liquid crystal molecules 39a under no voltage application. The projections 44 align the liquid crystal molecules 39a contacting the substrate surfaces in a direction slanted from the vertical direction. The vertical orientation type LCD displays “dark”.

Reference is made to FIG. 8B. FIG. 8B shows the orientation state of liquid crystal molecules 39a under voltage application. As a voltage is applied across transparent electrodes 35 and 36, the liquid crystal molecules 39a become aligned in a slanted direction relative to the substrate surface so that the multi domain structure can be realized. The vertical orientation type LCD displays “bright”.

The liquid crystal displays shown in FIGS. 7A and 7B and FIGS. 8A and 8B have a domain having good visualization in the 0° azimuth and a domain having good visualization in the 180° azimuth. The liquid display crystal display is suitable for a vehicle mounted liquid crystal display, with the 0°/180° direction being set parallel to the vehicle width direction.

In addition to the structures shown in FIGS. 7A and 7B and FIGS. 8A and 8B, other vertical orientation type LCDs of the multi domain structure are also suitable for a vehicle mounted liquid crystal display, such as a vertical orientation type LCD having a slit in the transparent electrode, projections on the transparent substrates, and/or a vertical orientation type LCD having a groove in the transparent substrate in place of projections.

The disclosed subject matter is applicable to a general vertical orientation type LCD regardless of whether it is a simple matrix type or an active matrix type. The disclosed subject matter is properly applied to a liquid crystal display having oblique observation as its main usage, particularly a vehicle mounted liquid crystal display having almost fixed display observation angles. The disclosed subject matter is also properly applied to a portable information terminal display which is often observed upward by a user. The vehicle can be any type of mobilization devie, such as planes, trains, automobiles, construction vehicles, etc.

The disclosed subject matter has been described in connection with exemplary embodiments. The disclosed subject matter is not limited only to the above embodiments. It will be apparent to those skilled in the art that other various modifications, improvements, combinations, and the like can be made.

What is claimed is:

1. A liquid crystal display comprising:
a first substrate and a second substrate disposed substantially parallel and facing each other;
a first electrode located adjacent an opposing surface of the first substrate;
a first vertical alignment film located adjacent the opposing surface of the first substrate and the first electrode;
a second electrode located adjacent an opposing surface of the second substrate;
a second vertical alignment film located adjacent the opposing surface of the second substrate and the second electrode;
a liquid crystal layer located between the first and second substrates;
a first polarizer having a first direction defining a transmission axis direction and disposed facing a surface of the first substrate opposite to the liquid crystal layer; and
a second polarizer having a second direction defining a transmission axis direction and disposed facing a surface of the second substrate opposite to the liquid crystal layer,
wherein the first and second polarizers are disposed, as viewed along a substantially normal direction of the first and second substrates, in such a manner that the first direction crosses the second direction at an angle other than a right angle to realize a normally black display.

2. The liquid crystal display according to claim 1, further comprising:
a first optical anisotropic film disposed between the first substrate and the first polarizer in such a manner that an in-plane direction of the first optical anisotropic film is substantially parallel to an in-plane direction of the first polarizer.

3. The liquid crystal display according to claim 2, wherein the first optical anisotropic film has negative uniaxial optical anisotropy.

4. The liquid crystal display according to claim 2, wherein the first optical anisotropic film has negative biaxial optical anisotropy, and a third direction in an in-plane direction of the first optical anisotropic film defines a delay phase axis.

5. The liquid crystal display according to claim 4, wherein a retardation in the in-plane direction of the first optical anisotropic film having negative biaxial optical anisotropy is greater than or equal to 1 nm and less than or equal to 80 nm.

6. The liquid crystal display according to claim 2, wherein a retardation in a depth direction of the first optical anisotropic film when a voltage is applied to the liquid crystal layer is between substantially 0.5 and substantially 1.2 times a retardation when no voltage is applied to the liquid crystal layer.

7. The liquid crystal display according to claim 4, wherein the first direction is one of substantially parallel and substantially perpendicular to the third direction.

8. The liquid crystal display according to claim 2, further comprising:
a second optical anisotropic film disposed between the second substrate and the second polarizer in such a manner that an in-plane direction of the second optical anisotropic film is substantially parallel to an in-plane direction of the second polarizer.

9. The liquid crystal display according to claim 8, wherein the second optical anisotropic film has negative uniaxial optical anisotropy.

10. The liquid crystal display according to claim 8, wherein the second optical anisotropic film has negative biaxial optical anisotropy, and a fourth direction in an in-plane direction of the second optical anisotropic film defines a delay phase axis.

11. The liquid crystal display according to claim 10, wherein a retardation in the in-plane direction of the second optical anisotropic film having negative biaxial optical anisotropy is greater than or equal to 1 nm and less than or equal to 80 nm.

12. The liquid crystal display according to claim 8, wherein a retardation in a depth direction of the second optical anisotropic film when a voltage is applied to the liquid crystal layer is between substantially 0.5 and substantially 1.2 times a retardation value when no voltage is applied to the liquid crystal layer.

13. The liquid crystal display according to claim 10, wherein the second direction is one of substantially parallel and substantially perpendicular to the fourth direction.

14. The liquid crystal display according to claim 10, wherein a third direction in an in-plane direction of the first optical anisotropic film defines a delay phase axis, and the third direction is a direction not parallel and not perpendicular to the fourth direction.

15. The liquid crystal display according to claim 1, wherein the first and second polarizers are disposed, as viewed along a normal direction to the first and second substrates, in such a manner that the first direction crosses the second direction at an angle which is between substantially 90° and substantially 96°.

16. The liquid crystal display according to claim 1, wherein the first and second polarizers are disposed, as viewed along a normal direction to the first and second substrates, in such a manner that the first direction crosses the second direction at an angle which is between substantially 91° and substantially 95°.

17. The liquid crystal display according to claim 1, wherein the first vertical alignment film covers the first electrode and the second vertical alignment film covers the second electrode.

18. The liquid crystal display according to claim 1, wherein at least one of the first electrode and the second electrode includes a slit.

19. The liquid crystal display according to claim 1, wherein at least one of the first electrode and the second electrode includes at least one projection.

20. A liquid crystal display comprising:
a first substrate and a second substrate disposed substantially parallel and facing each other;
a first electrode located adjacent the first substrate;
a first vertical alignment film located adjacent the first electrode;
a second electrode located adjacent the second substrate;
a second vertical alignment film located adjacent the second electrode;
a liquid crystal layer located between the first and second substrates;
a first polarizer disposed adjacent the first substrate and having a first transmission axis direction;
a second polarizer disposed adjacent the second substrate and having a second transmission axis direction; and
a phase difference film disposed between the first substrate and the first polarizer,
wherein the first and second polarizers are disposed, as viewed along a substantially normal direction of the first and second substrates, in such a manner that the first transmission axis direction forms an angle between zero and ninety degrees with respect to the second transmission axis direction.
